(19) United States
(12) Patent Application Publication
(10) Pub. No.: US 2006/0197772 A1
(43) Pub. Date: Sep. 7, 2006

(54) Apparatus and method for mobile thermal texture mapping

(76) Inventor: Zhongqi Liu, Beijing (CN)

Correspondence Address: TUCKER, ELLIS & WEST LLP, 1150 HUNTINGTON BUILDING, 925 EUCLID AVENUE, CLEVELAND, OH, 44115-1414, US

(21) Appl. No.: 11/069,358

(22) Filed: Mar. 1, 2005

(51) Int. Cl. G09G 5/00

(52) U.S. Cl. 345/582

(57) ABSTRACT

The present invention provides a mobile type of thermal texture mapping apparatus, which includes a scanning head, a direction-controlling floating table, a scanning head direction-controller, a central processing unit, a self-contained and/or external power supply, as well as a mobile box, the mobile box could contain all the above-said elements. This box is composed of 2-3 coupling boxes. Each coupling box has up-down sliding rails and guiding slots between them. Outside the mobile box, there are handles and trolley wheels convenient for dragging the box. Because all elements are capable of being compacted into the mobile box, the height of the scanning head is able to be adjusted by adjusting the height of the coupling boxes, no extra movement, except rotation, is needed for the patient, so the apparatus occupies only a small space, convenient for field or emergency clinic diagnosis

### BACKGROUND OF THE INVENTION

This invention is directed to an apparatus and method for thermal texture mapping. More particularly, this invention is directed to a method and apparatus for performing thermal texture mapping evaluations in mobile and emergency clinic diagnosis applications.

Thermal texture mapping has attracted wide attention from the scientific and medical fields in recent years. Most particularly, application of thermal texture mapping has enabled the medical field to study the inner thermal source from infrared thermal radiation data obtained from a human body surface. This studying has led to the establishment of hundreds of relationships between diseases/sub-healthy status and inner thermal sources through statistical work on a plurality of medical cases and their corresponding thermal texture mapping scanning data.

The typical thermal texture mapping apparatus consists of an operation and central processing system, a scanning system, and a scanning bed. The operation and central processing system includes a console, central processing unit, color display, color printer and various other components known in the art. An operator controls the scanning system and the scanning bed of the typical thermal mapping apparatus through the console. The scanning system generally consists of three units: a scanning head, a scanning shelf, and a shelf cover. First generation thermal texture mapping apparatuses had the scanning shelf located inside the shelf cover, while newer apparatuses combine the scanning shelf and the shelf cover into one part while the scanning head is placed on the scanning shelf via a floating table.

Through the console, the scanning head is able to perform lift-fall, left-right, up-down, rotating scanning, and image focus scanning. The scanning bed is typically capable of moving forward and backward along rails. A rotary table at the lower portion of the bed enables 360 degree clockwise or counterclockwise rotation to meet scanning requirements. As is apparent from the first and second generation devices described above, these apparatuses require a large amount of space, as well as high standards for both supply power and application environment. In addition, these large apparatuses are difficult to move and lack the ability to be used in mobile or emergency conditions. It would be desirable to have a thermal texture mapping apparatus capable of deployment in field and emergency clinic diagnosis applications.

The subject invention overcomes the aforementioned problems and provides a method and apparatus for thermal texture mapping in emergency clinic diagnosis application for people in remote areas and for mobile applications.

### SUMMARY OF THE INVENTION

In accordance with the present invention, there is provided an apparatus and method for thermal texture mapping.

Further, in accordance with the present invention, there is provided an apparatus and method for thermal texture mapping for thermal texture mapping in mobile and emergency clinic diagnosis applications.

Still further, in accordance with the present invention, there is provided a mobile thermal texture mapping apparatus, comprising an infrared scanning head; a direction-controlling floating table located a movable distance below the infrared scanning head; a scanning direction controller communicatively coupled to the infrared scanning head; a central processing unit in operative communication with the infrared scanning head and the direction-controlling floating table; and an enclosure adapted to contain the infrared scanning head, the direction-controlling floating table, the scanning direction controller, and the central processing unit, wherein the enclosure is configured to expand and contract for movement.

In a preferred embodiment, the enclosure further comprises a plurality of coupling boxes suitably adapted to expand from the enclosure and collapse into the enclosure. The plurality of coupling boxes are engagably attached to the enclosure via a plurality of vertical sliding rails. A plurality of guiding slots are disposed between each of the plurality of vertical sliding rails enabling movement of the coupling boxes in a vertical direction; and at least one of the group consisting of a plurality of blocks and a plurality of pins configured to removably engage the sliding rails and the coupling boxes, wherein the coupling boxes are removably secured

Yet further, in accordance with the present invention, there is provided a method for thermal texture mapping in a remote environment. An instruction is given to a direction-controlling floating table via a floating table controller. The scanning direction is adjusted to a proper determined distance via the direction-controlling floating table. Heat radiated during the metabolism course of human cells is then detected by the scanning head and translated into digital signals. The digital signals are transmitted to the central processing unit. Following the thermal texture mapping processing, a thermal radiation distribution map, reflecting the relative metabolism intensity of the detected body parts is generated and displayed. Further analysis is then made by the operator to judge the health of the human body.

Still other aspects of the present invention will become readily apparent to those skilled in the art from the following description wherein there is shown and described a preferred embodiment of this invention, simply by way of illustration of one of the best modes best suited for to carry out the invention. As it will be realized, the present invention is capable of other different embodiments and its several details are capable of modifications in various obvious aspects all without from the invention. Accordingly, the drawing and descriptions will be regarded as illustrative in nature and not as restrictive.

### BRIEF DESCRIPTION OF THE FIGURES

The accompanying drawings incorporated in and forming a part of the specification, illustrate several aspects of the present invention, and together with the description server to explain the principals of the invention. In the drawings:

FIG. 1 is a block diagram illustrative of a mobile thermal texture mapping apparatus in accordance with the present invention;

FIG. 2 is a flowchart illustrative of a method in accordance with the present invention; and

FIG. 3 is a block diagram illustrative of the mobile thermal texture mapping apparatus in a movable state in accordance with the present invention.

These and additional embodiments of the invention may now be better understood by turning to the following detailed description wherein an illustrated embodiment is described.

### DETAILED DESCRIPTION OF THE PREFERRED EMBODIMENT

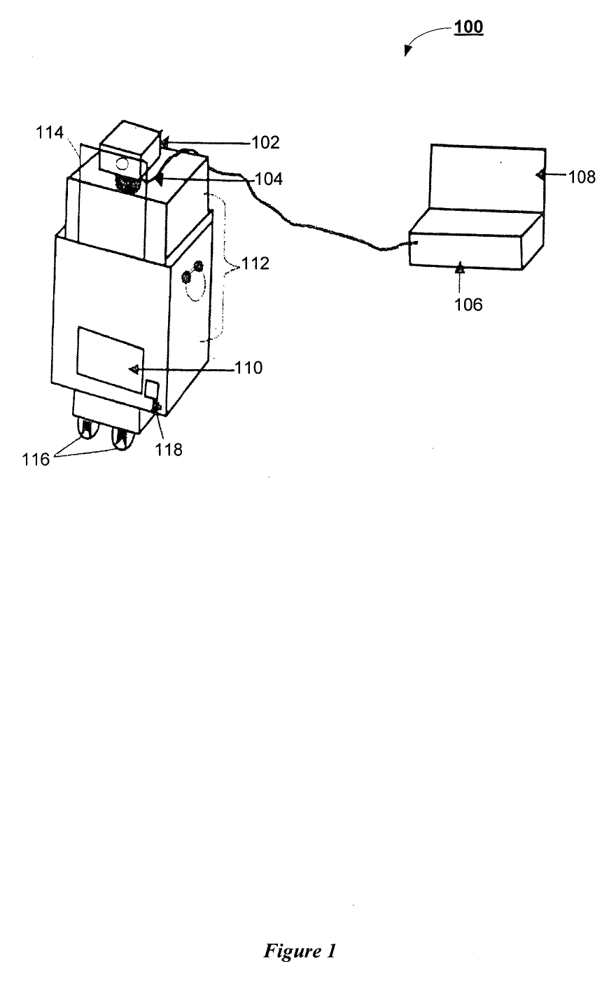

The present invention is directed to an apparatus and method for thermal texture mapping. More particularly, the present invention is directed to an apparatus and method for thermal texture mapping for thermal texture mapping in mobile and emergency clinic diagnosis applications. U.S. Pat. No. 6,023,637 discusses fundamental information regarding thermal texture mapping techniques, the relevant contents thereof are hereby incorporated by reference herein. Turning now to FIG. 1, there is shown an expanded view of the mobile thermal texture mapping apparatus 100 in accordance with the present invention. As shown in FIG. 1, the apparatus 100 includes an infrared scanning head 102, a direction-controlling floating table 104, a scanning head direction-controller 106, a central processing unit 108, a self-contained power source 110, and an external power interface 118. As will be appreciated by those skilled in the art, the self-contained power source 110 is any portable power supply known in the art and capable of providing power to the electronic components contained in the apparatus 100.

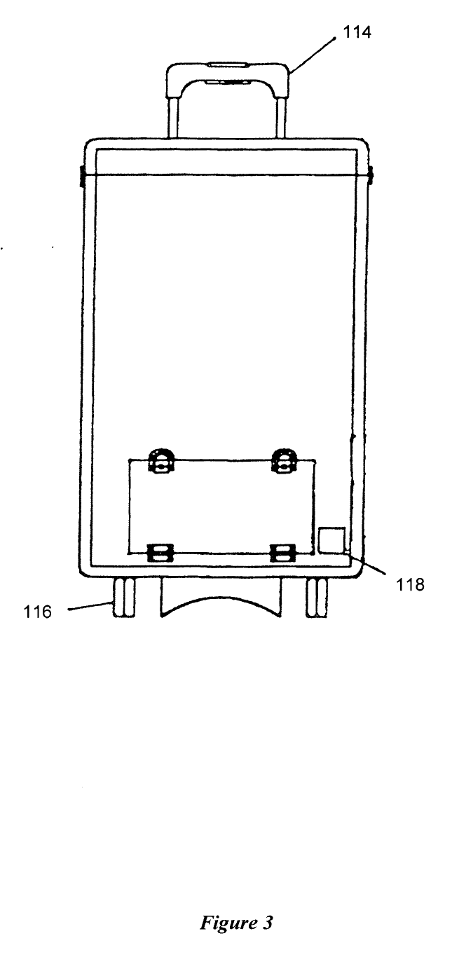

The scanning head 102 is suitably located on the direction-controlling floating table 104. The scanning head 102 is communicatively coupled to the central processing unit 108 and the scanning head direction-controller 106 via communications lines as known in the art. The central processing unit 108 and the scanning head direction-controller 106 are suitably removable from the apparatus 100 as shown in FIG. 1. The removable nature of the central processing unit 108 and the scanning head direction-controller 106 enables an operator to perform scanning and data processing. The power supply 110 and the external power interface 118 are suitably located on the exterior of the apparatus 100. In addition, the apparatus 100 comprises a mobile box 112, which is capable of storing all associated apparatus 100 components for travel, as illustrated in the compacted view of the mobile box 112 shown in FIG. 3.

In the preferred embodiment, the mobile box 112 advantageously includes 2-3 coupling boxes. The power supply 110 is located, as shown in FIG. 1, in the bottom portion of the mobile box 112. Not shown are the sliding up-down guide rails and guiding slots between these boxes for adjusting the height of the scanning head 102. On the rails and slots are located blocks, or alternatively a pin-type fixture, to fix the position of the scanning head 102 relative to the table 104 at varying respective distances between the two. Advantageously located on at least one side of the mobile box 112, along the external vertical sides of said box 112 is a handle 114, which is configured to be pulled out and pushed in during transport of the box. The mobile box 112 suitably includes wheels 116 located on the bottom of the box 116 to enable ease of movement of the box, as well as providing support to the box 112 when at rest. The external interface 118 is suitably configured to accept a variety of plug interfaces for electrical power as is known in the art.

In the preferred embodiment, the direction-controlling floating table 104 is extracted from the mobile box 112 and stably supported by the inner wall of the box 112 during operation. The inner boxes are pulled upwards and fixed at a height with the outer boxes to form a stable support for the floating table 104. In addition, the preferred embodiment uses a 12V DC power supply, contained in the internal power supply 110. External 12V power is capable of being received from, for example and without limitation, an automobile battery or engine. The self-contained power supply 110 is preferably a battery adapted to provide the apparatus 100 with electrical power for 40-60 minutes of operation. To perform longer operations, the apparatus 100 uses the external interface 118 to receive 220V or 110V commercial power, with a suitable transformer adapted to transfer the AC 220V or 110V into 12V DC, or for example, to recharge the internal power supply 110. In addition thereto, the apparatus 100 is capable of receiving power from a man-powered generating device, as is known in the art.

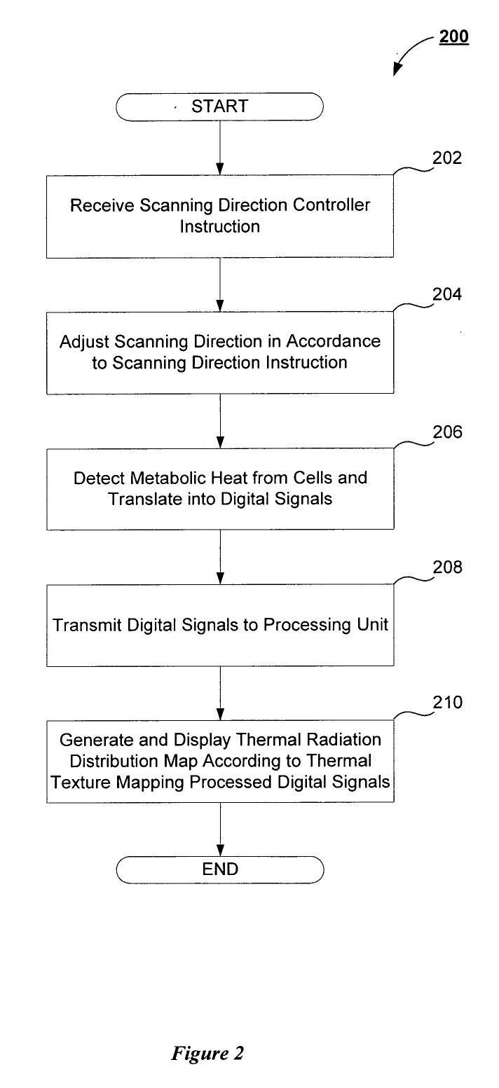

Turning now to FIG. 2, there is shown a flowchart 200 illustrating the operation of the subject invention. An instruction is given to the direction-controlling floating table 104 via the floating table controller 106 at step 202. At step 204, the scanning direction is adjusted to a proper determined distance via the direction-controlling floating table 104. Heat radiated during the metabolism course of human cells is then detected by the scanning head 102 at step 206 and translated into digital signals. At step 208, the digital signals are transmitted to the central processing unit 108. Following the thermal texture mapping processing, a thermal radiation distribution map, reflecting the relative metabolism intensity of the detected body parts is generated and displayed at step 210. Further analysis is then made by the operator to judge the health of the human body.

The invention extends to computer programs in the form of source code, object code, code intermediate sources and object code (such as in a partially compiled form), or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the invention principles as described, will fall within the scope of the invention.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed:

1. A mobile thermal texture mapping apparatus, comprising:
an infrared scanning head;
a direction-controlling floating table located a movable distance below the infrared scanning head;
a scanning direction controller communicatively coupled to the infrared scanning head;
a central processing unit in operative communication with the infrared scanning head and the direction-controlling floating table; and
an enclosure adapted to contain the infrared scanning head, the direction-controlling floating table, the scanning direction controller, and the central processing unit, wherein the enclosure is configured to expand and contract for movement.

2. The mobile thermal texture mapping apparatus of claim 1, further comprising at least one of an internal power supply and an external power supply.

3. The mobile thermal texture mapping apparatus of claim 2, wherein the at least one of an internal power supply and an external power supply is a 12V DC power supply.

4. The mobile thermal texture mapping apparatus of claim 3, wherein the 12V DC power supply is one of the group consisting of a self-contained accumulator, an internal combustion engine, a man-powered generator, and a transformer, wherein the transformer is suitably connected to one of an AC 220 and an AC 110 power line.

5. The mobile thermal texture mapping apparatus of claim 1, wherein the enclosure further comprises a plurality of coupling boxes suitably adapted to expand from the enclosure and collapse into the enclosure.

6. The mobile thermal texture mapping apparatus of claim 5, wherein the plurality of coupling boxes are engagably attached to the enclosure via a plurality of vertical sliding rails, further comprising:
a plurality of guiding slots disposed between each of the plurality of vertical sliding rails enabling movement of the coupling boxes in a vertical direction; and
at least one of the group consisting of a plurality of blocks and a plurality of pins configured to removably engage the sliding rails and the coupling boxes, wherein the coupling boxes are removably secured.

7. The mobile thermal texture mapping apparatus of claim 1, wherein the enclosure further comprises:
a handle disposed on at least one of the vertical sides of the enclosure, the handle slideably engaged with at least one vertical side; and
a plurality of wheels, attached to the bottom of the enclosure and suitably adapted to provide movement of the apparatus.

8. A method for thermal texture mapping using a mobile apparatus comprising the steps of:
receiving a scanning direction controller signal via a floating table controller;
adjusting a scanning direction in accordance with the scanning direction controller signal;
detecting metabolic heat via a scanning head;
translating the metabolic heat detected by the scanning head into digital data;
generating a thermal radiation distribution map of the digital data based on thermal texture mapping.
